(19) United States
(12) Patent Application Publication
(10) Pub. No.: US 2021/0223657 A1
(43) Pub. Date: Jul. 22, 2021

(54) ACTIVE PHOTONIC NETWORKS ON INTEGRATED LITHIUM NIOBATE PLATFORMS

(71) Applicant: President and Fellows of Harvard College, Cambridge, MA (US)

(72) Inventors: Cheng Wang, Cambridge, MA (US); Mian Zhang, Cambridge, MA (US); Marko Loncar, Cambridge, MA (US)

(21) Appl. No.: 17/051,679

(22) PCT Filed: Apr. 30, 2019
(86) PCT No.: PCT/US2019/030006

§ 371 Date: Oct. 29, 2020

Related U.S. Application Data
(60) Provisional application No. 62/664,893, filed on Apr. 30, 2018.

(51) Int. Cl. G02F 1/21; G02F 1/03

(52) U.S. Cl. CPC G02F 1/212; G02F 1/0316

(57) ABSTRACT

Active photonic networks on integrated lithium niobate platforms are provided. In various embodiments, a plurality of Mach-Zehnder interferometers is provided. Each Mach-Zehnder interferometer has an input and two outputs. Each Mach-Zehnder interferometer comprises at least one electrode operative to control the phase or intensity of at least one of the outputs. The plurality of Mach-Zehnder interferometers are optically interconnected. At least one controller is electrically coupled to the at least one electrode of each of the plurality of Mach-Zehnder interferometers. The controller is operative to individually control each electrode.

### CROSS-REFERENCE TO RELATED APPLICATIONS

This application claims the benefit of U.S. Provisional Application No. 62/664,893, filed Apr. 30, 2018, which is hereby incorporated by reference in its entirety.

### BACKGROUND

Embodiments of the present disclosure relate to electro-optic platforms, and more specifically, to active photonic networks on integrated lithium niobate platforms.

### BRIEF SUMMARY

According to embodiments of the present disclosure, active photonic networks and methods for operating such networks are provided.

In various embodiments, a device is provided, comprising: a plurality of Mach-Zehnder interferometers, each Mach-Zehnder interferometer having an input and two outputs, each Mach-Zehnder interferometer comprising at least one electrode operative to control the phase or intensity of at least one of the outputs, the plurality of Mach-Zehnder interferometers being optically interconnected; at least one controller electrically coupled to the at least one electrode of each of the plurality of Mach-Zehnder interferometers, the controller operative to individually control each electrode.

In some embodiments, the plurality of Mach-Zehnder interferometers are optically interconnected in series. In some embodiments, the plurality of Mach-Zehnder interferometers are optically interconnected in a tree. In some embodiments, the plurality of Mach-Zehnder interferometers are optically interconnected in an array.

In some embodiments, each Mach-Zehnder interferometer comprises a waveguide comprising a second-order nonlinear material. In some embodiments, each Mach-Zehnder interferometer comprises a waveguide comprising lithium niobate. In some embodiments, the waveguide is elongated in a direction perpendicular to a z-axis of the lithium niobate. In some embodiments, the waveguide is elongated in a direction perpendicular to an x-axis of the lithium niobate.

In some embodiments, each Mach-Zehnder interferometer comprises a waveguide comprising lithium tantalate. In some embodiments, the waveguide is elongated in a direction perpendicular to a z-axis of the lithium tantalate. In some embodiments, the waveguide is elongated in a direction perpendicular to an x-axis of the lithium tantalate.

In some embodiments, each Mach-Zehnder interferometer comprises a first and second arm, and wherein a first electrode of the at least one electrode of each Mach-Zehnder interferometer is disposed parallel to the first and second arm of the corresponding Mach-Zehnder interferometer. In some embodiments, the first electrode is disposed between and coplanar to the first and second arm of the corresponding Mach-Zehnder interferometer. In some embodiments, a second electrode of the at least one electrode of each Mach-Zehnder interferometer is disposed parallel to the first and second arm of the corresponding Mach-Zehnder interferometer. In some embodiments, the second electrode is disposed coplanar to the first and second arm of the corresponding Mach-Zehnder interferometer, the first arm being disposed between the first electrode and the second electrode. In some embodiments, a third electrode of the at least one electrode of each Mach-Zehnder interferometer is disposed parallel to the first and second arm of the corresponding Mach-Zehnder interferometer. In some embodiments, the third electrode is disposed coplanar to the first and second arm of the corresponding Mach-Zehnder interferometer, the second arm being disposed between the first electrode and the third electrode.

In some embodiments, each output of each Mach-Zehnder interferometer has an electro-optic coefficient of at least 2 pm/V. In some embodiments, the at least one electrode has an efficiency of at most 10 V*cm.

In some embodiments, each of the plurality of Mach-Zehnder interferometers comprises a ridge portion extending from a slab portion, the ridge portion having a height perpendicular to the slab portion and a width parallel to the slab portion. In some embodiments, the ridge portion has a cross sectional area of at most 5 μm². In some embodiments, the ridge portion has a cross sectional area of at most 2 μm². In some embodiments, the slab portion has a thickness of 5 nm to 1000 nm. In some embodiments, the height of the ridge portion is from 50 nm to 1000 nm. In some embodiments, the width of the ridge portion is from 100 nm to 5000 nm. In some embodiments, the width of the ridge portion is from 100 nm to 5000 nm.

In some embodiments, the plurality of Mach-Zehnder interferometers comprise a SiO2 cladding.

In various embodiments, a device is provided, comprising: a plurality of beam splitters, each beam splitter having an input and two outputs, the plurality of beam splitters being optically interconnected in a tree having an optical input and a plurality of optical outputs; a plurality of electrodes, each operative to control the phase of one of the optical outputs; at least one controller electrically coupled to the plurality of electrodes, the controller operative to individually control each electrode.

In some embodiments, each of the plurality of optical outputs comprises a waveguide comprising a second-order nonlinear material. In some embodiments, each of the plurality of optical outputs comprises a waveguide comprising lithium niobate. In some embodiments, the waveguide is elongated in a direction perpendicular to a z-axis of the lithium niobate. In some embodiments, the waveguide is elongated in a direction perpendicular to an x-axis of the lithium niobate. In some embodiments, each of the plurality of optical outputs comprises a waveguide comprising lithium tantalate. In some embodiments, the waveguide is elongated in a direction perpendicular to a z-axis of the lithium tantalate. In some embodiments, the waveguide is elongated in a direction perpendicular to an x-axis of the lithium niobate.

In some embodiments, each output of each beam splitter has an electro-optic coefficient of at least 2 pm/V. In some embodiments, the at least one electrode has an efficiency of at most 10 V*cm.

In some embodiments, each of the plurality of beam splitters comprises a ridge portion extending from a slab portion, the ridge portion having a height perpendicular to the slab portion and a width parallel to the slab portion. In some embodiments, the ridge portion has a cross sectional area of at most 5 μm². In some embodiments, the ridge portion has a cross sectional area of at most 2 μm². In some embodiments, the slab portion has a thickness of 5 nm to 1000 nm. In some embodiments, the height of the ridge portion is from 50 nm to 1000 nm. In some embodiments, the width of the ridge portion is from 100 nm to 5000 nm. In some embodiments, the width of the ridge portion is from 100 nm to 5000 nm.

In some embodiments, the plurality of beam splitters comprise a SiO2 cladding.

In various embodiments a device is provided, comprising: a plurality of layers, each layer comprising: a plurality of beam splitters, each beam splitter having an input and two outputs, the plurality of beam splitters being optically interconnected in a tree having an optical input and a plurality of optical outputs; a plurality of electrodes, each operative to control the phase of one of the optical outputs; at least one controller electrically coupled to the plurality of electrodes of each layer, the controller operative to individually control each electrode; a planar array of optical outputs, optically coupled to the optical outputs of each layer.

In some embodiments, each of the plurality of optical outputs of each layer comprises a waveguide comprising a second-order nonlinear material. In some embodiments, each of the plurality of optical outputs of each layer comprises a waveguide comprising lithium niobate. In some embodiments, the waveguide is elongated in a direction perpendicular to a z-axis of the lithium niobate. In some embodiments, the waveguide is elongated in a direction perpendicular to an x-axis of the lithium niobate.

In various embodiments, a method of beam-steering is provided. An optical input is provided to a plurality of beam splitters, each beam splitter having an input and two outputs, the plurality of beam splitters being optically interconnected in a tree having an optical input and a plurality of optical outputs. Each of a plurality of electrodes is individually controlled by a controller, the controller electrically coupled to the plurality of electrodes, each of the plurality of electrodes operative to control the phase of one of the optical outputs.

In some embodiments, each of the plurality of optical outputs comprises a waveguide comprising a second-order nonlinear material. In some embodiments, each of the plurality of optical outputs comprises a waveguide comprising lithium niobate. In some embodiments, In some embodiments, the waveguide is elongated in a direction perpendicular to a z-axis of the lithium niobate. In some embodiments, the waveguide is elongated in a direction perpendicular to an x-axis of the lithium niobate. In some embodiments, each of the plurality of optical outputs comprises a waveguide comprising lithium tantalate. In some embodiments, the waveguide is elongated in a direction perpendicular to a z-axis of the lithium tantalate. In some embodiments, the waveguide is elongated in a direction perpendicular to an x-axis of the lithium niobate.

In some embodiments, each output of each beam splitter has an electro-optic coefficient of at least 2 pm/V. In some embodiments, the at least one electrode has an efficiency of at most 10 V*cm.

In some embodiments, each of the plurality of beam splitters comprises a ridge portion extending from a slab portion, the ridge portion having a height perpendicular to the slab portion and a width parallel to the slab portion. In some embodiments, the ridge portion has a cross sectional area of at most 5 μm². In some embodiments, the ridge portion has a cross sectional area of at most 2 μm². In some embodiments, the slab portion has a thickness of 5 nm to 1000 nm. In some embodiments, the height of the ridge portion is from 50 nm to 1000 nm. In some embodiments, the width of the ridge portion is from 100 nm to 5000 nm. In some embodiments, the width of the ridge portion is from 100 nm to 5000 nm. In some embodiments, the plurality of beam splitters comprise a SiO2 cladding.

### BRIEF DESCRIPTION OF THE SEVERAL VIEWS OF THE DRAWINGS

FIGS. 1A-C are schematic views of thin-film electro-optic phase modulator (EOPM) designs, according to embodiments of the present disclosure.

FIGS. 2A-B are schematic views of modulator (MOD) designs, according to embodiments of the present disclosure.

FIGS. 3A-C are cross-sectional views of electrode configurations according to embodiments of the present disclosure.

FIG. 4 is a schematic view of a large-scale active electro-optic platform based on lithium niobate nanophotonics according to embodiments of the present disclosure.

FIG. 5 is a schematic view of a push-pull configuration of phase control according to embodiments of the present disclosure.

FIG. 6 is a schematic of an exemplary electro-optical switch network according to embodiments of the present disclosure.

FIG. 7 is a schematic of another exemplary electro-optical switch network according to embodiments of the present disclosure.

FIG. 8 is a schematic of a LiDAR system based on lithium niobate electro-optic platform according to embodiments of the present disclosure.

FIG. 9 is a schematic view of a highly multiplexed spatial light modulator based on lithium niobate electro-optic platform according to embodiments of the present disclosure.

FIG. 10 is a schematic of an exemplary Mach-Zehnder interferometer (MZI) switch network for optical information processing according to embodiments of the present disclosure.

FIG. 11 is a schematic view of a universal N-to-N unitary electro-optic transformer according to embodiments of the present disclosure.

FIG. 12 is a schematic view of an additional block configuration for a universal N-to-N unitary electro-optic transformer according to embodiments of the present disclosure.

### DETAILED DESCRIPTION

The present disclosure provides various design and related methods for large-scale photonic networks with active control of the amplitude and phase of each channel, based on an integrated lithium niobate (x-cut or z-cut LN, lithium tantalate, KNbO₃ and other χ2 materials) electro-optic platform.

The present disclosure provides various photonic network structures using electro-optic components. These systems use the electro-optic effect enabled by thin-film lithium niobate/lithium tantalate material systems. Alternative systems may use very high optical loss modulators or high power consuming and slow thermo-optic tuning methods. Such approaches prevent construction of large optical networks. The electro-optic methods provided herein are faster and consume less electrical power. The electro-optic platforms provided herein address a need for photonic switch networks on chip.

Machine vision, light-detection and ranging (LiDAR), sensing, holography, and quantum computation demand photonic systems that have multiple (preferably >100) output optical channels, with each one individually accessible and controllable at high speed. Various systems may be controlled using mechanical (MEMS) or thermal approaches, which are usually slow (kHz-MHz) and cannot be scaled up easily. Thermal approaches also consume a lot of static power.

The present disclosure provides lithium niobate nanophotonic platforms and their electro-optic effect to realize the active photonic platform. Low voltage (e.g., a few volts), high-speed (>40 GHz) electro-optic control of the phase and amplitude of light can be realized on-chip and in a very compact way.

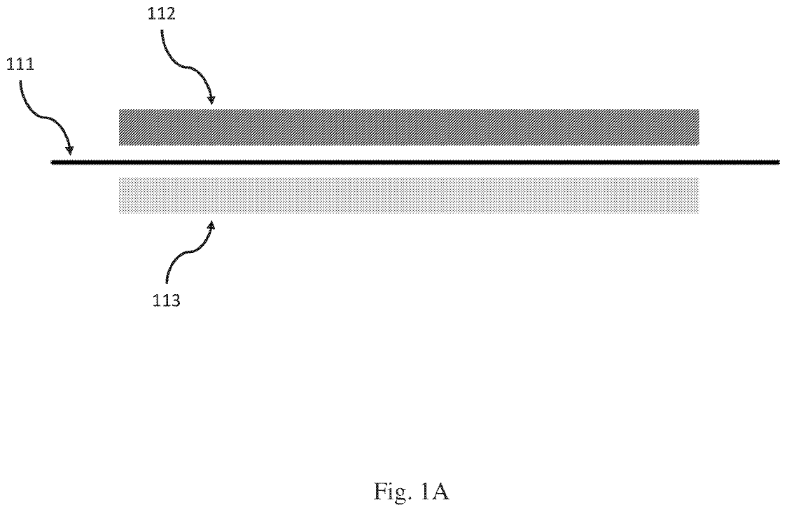

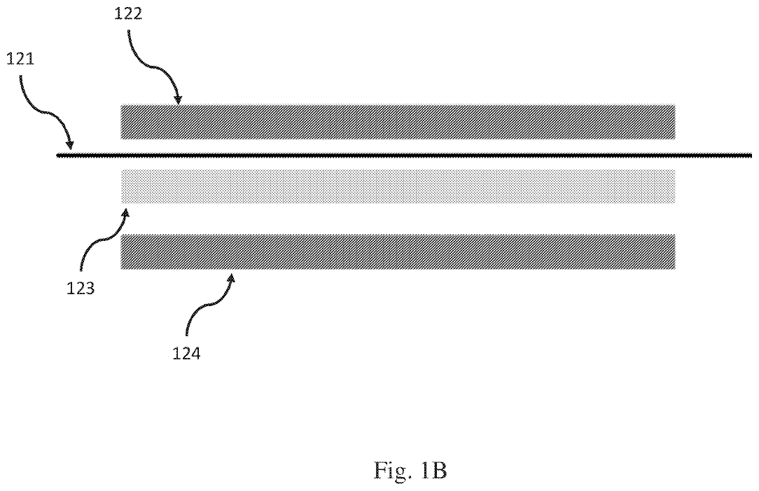

FIGS. 1A-C are schematic views of thin-film electro-optic phase modulator (EOPM) designs, according to embodiments of the present disclosure. These figures shows electrically active component of a switch network on thin-film lithium niobate/tantalate, the thin-film electro-optic phase modulator (or EOPM). Solid lines 111, 121, 131 represent monolithically etched thin-film lithium niobate micrometer scale waveguides. The shaded regions 112, 113, 122, 123, 124, 132, 133, 134 represent electrodes. The three figures correspond to three designs that perform the function of EOPM. FIG. 1A uses a pair of co-planar electrical contacts 112, 113 with a ground-signal configuration. FIG. 1B uses a co-planar electrical transmission line with a ground-signal-ground (122, 123, 124) configuration. FIG. 1C uses a co-planar electrical transmission line with a ground-signal-ground (132, 133, 134) configuration, but also a pair of optical waveguides 135, 136 that have opposite phase shift for a given applied electrical signal.

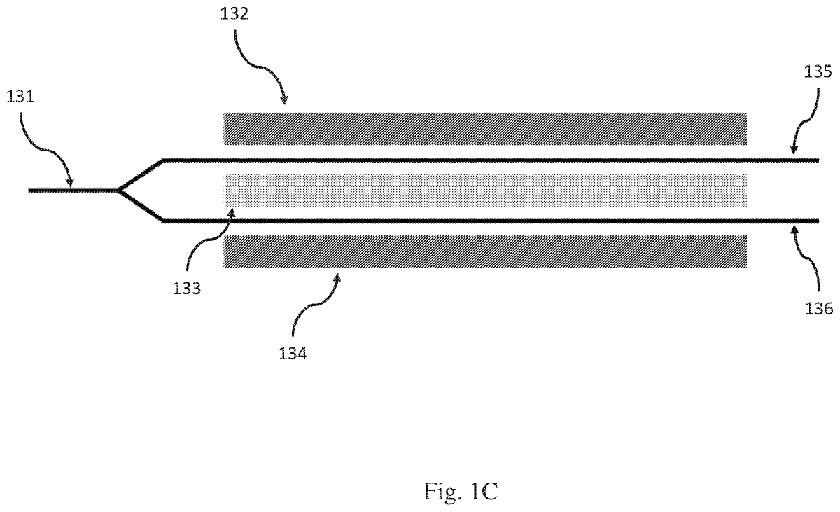

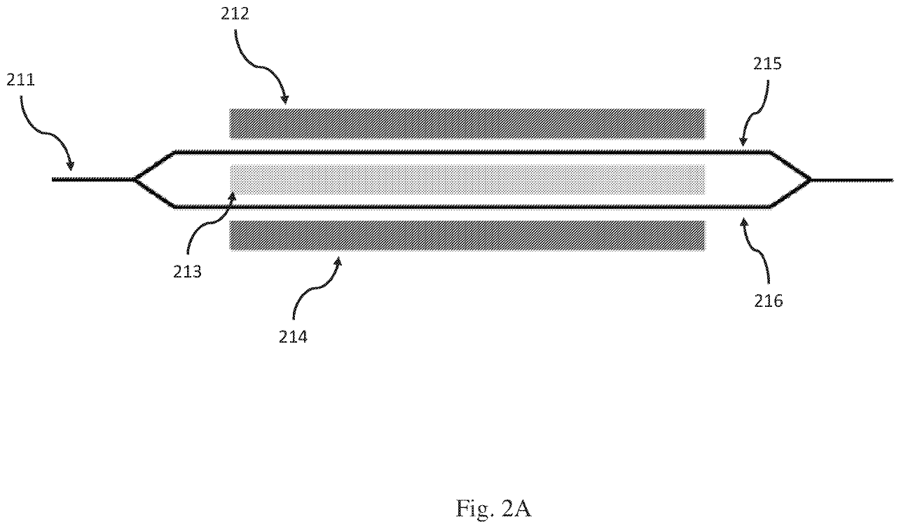

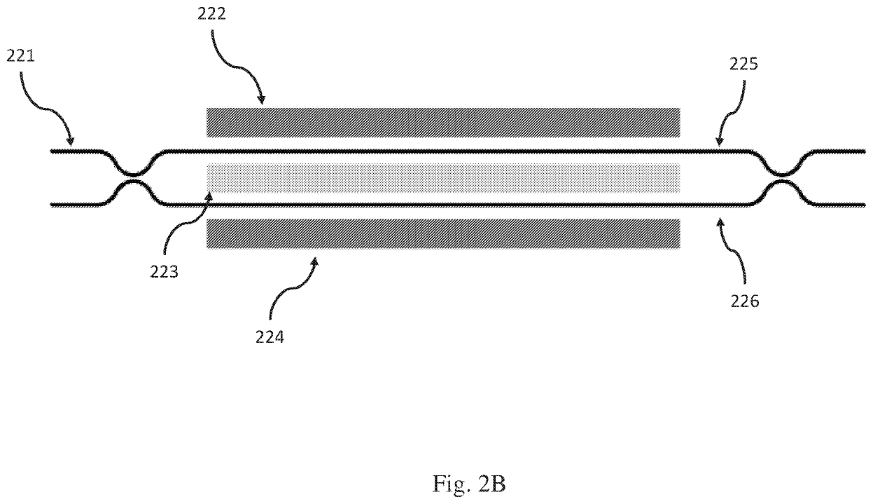

FIGS. 2A-B are schematic views of modulator (MOD) designs, according to embodiments of the present disclosure. These figures show the active component of a modulator (MOD), where the solid lines 211, 221 represent monolithically etched thin-film lithium niobate/tantalate micrometer scale waveguides. The shaded regions 212, 213, 214, 222, 223, 224 represent electrodes. These figures show two designs that use a co-planar electrical transmission line with a ground-signal-ground (212, 213, 214 and 222, 223, 224) configuration, but also a pair of optical waveguides (215, 216 and 225, 226) that have opposite phase shift for a given applied electrical signal. The modulator uses a Mach-Zehnder configuration that changes the intensity of light in the design of FIG. 2A and changes the relative ratio of the light in the two outputs in the design of FIG. 2B.

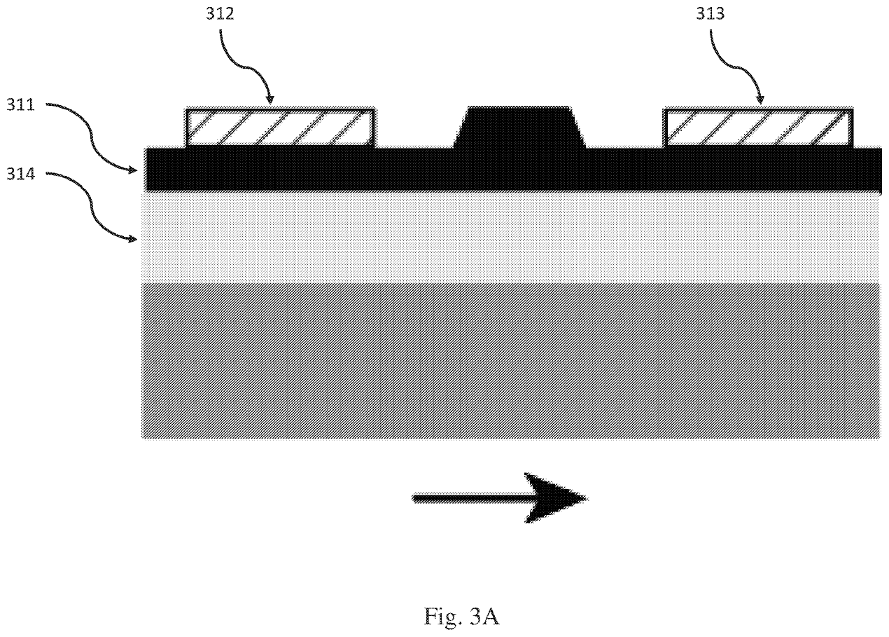

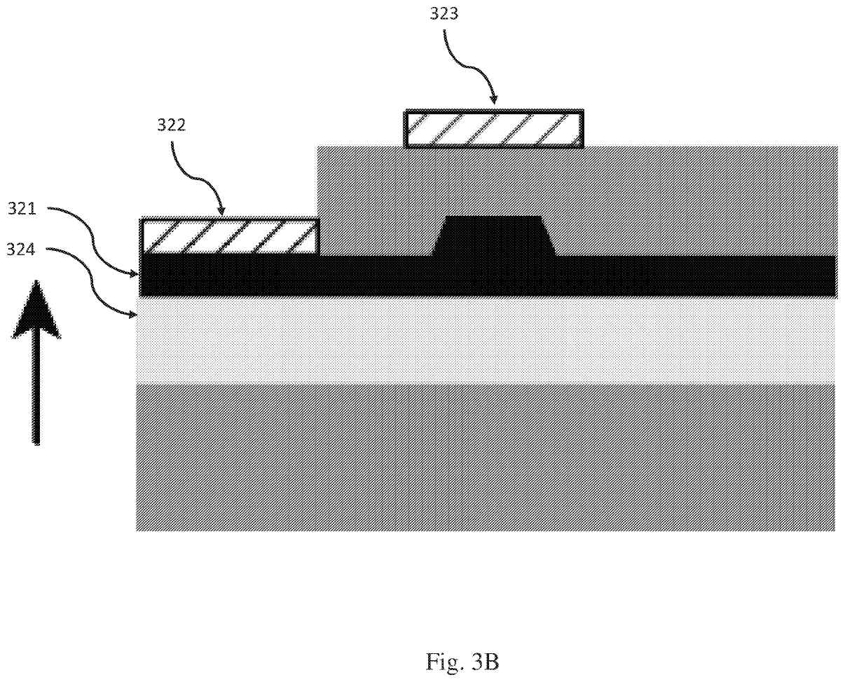

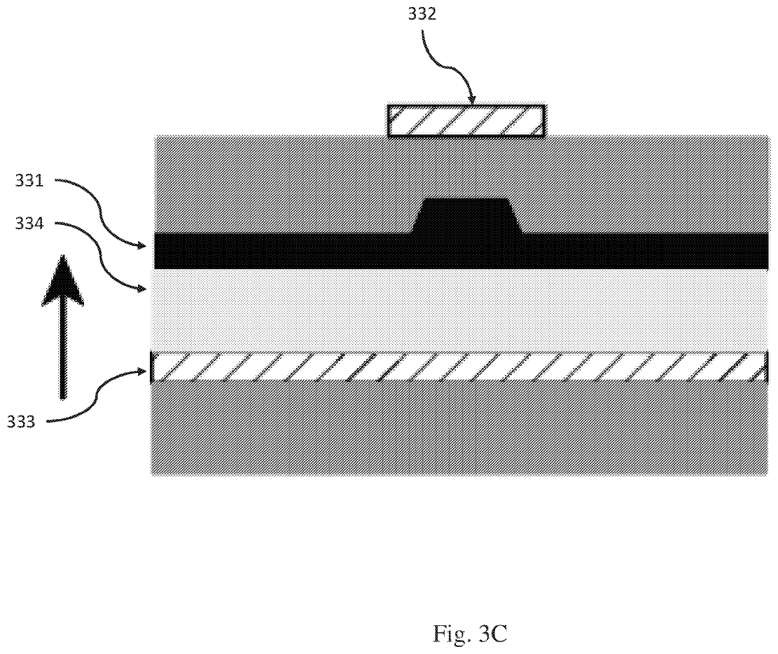

FIGS. 3A-C are cross-sectional views of electrode configurations according to embodiments of the present disclosure. These figures illustrate the cross section of the possible layout of the metals in various embodiments. FIG. 3A shows an exemplary configuration for x-cut lithium niobate. FIG. 3B shows an exemplary configuration for z-cut thin-film LN. FIG. 3C shows a second exemplary configuration for z-cut thin-film LN. Black regions 311, 321, 331 represent thin-film LN, with the arrow indicating the z-axis. White areas 312, 313, 322, 323, 332, 333 represent metal electrodes. Shaded area 314, 324, 334 represent a substrate, such as SiO₂.

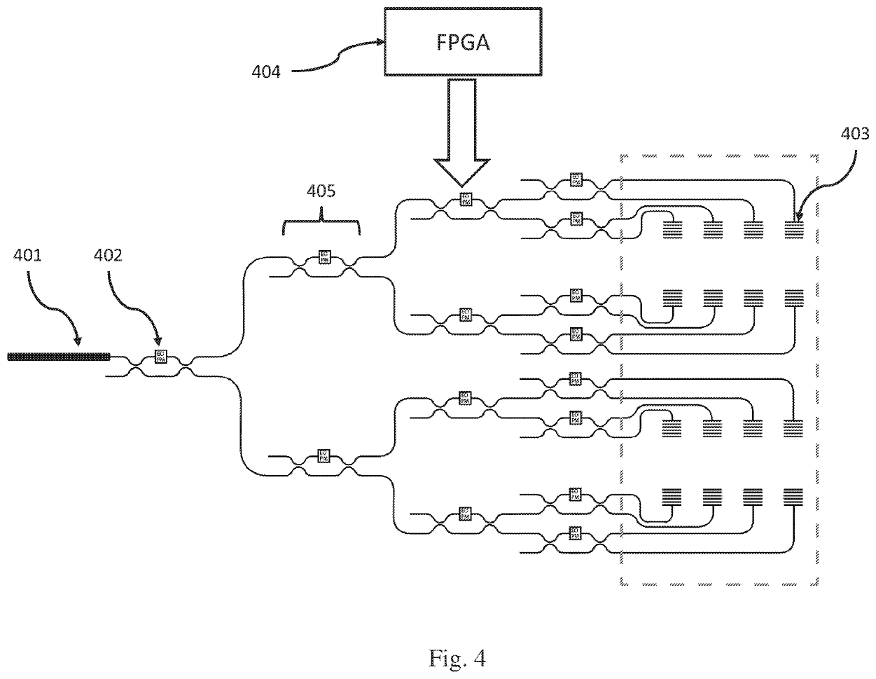

FIG. 4 is a schematic of a large-scale active electro-optic platform based on lithium niobate nanophotonics. In particular, a switch network made of cascaded thin-film lithium niobate electro-optic devices is provided. In this example, light is provided from one arm on the left side of the network, for example via fiber 401. An electro-optic modulator 402, in this example a first Mach-Zehnder switch modulator, determines whether the light goes through the top or the bottom paths, or a combination of both. This switching process cascades to provide 2^{N} output ports 403 (e.g., grating couplers) where N is the number of cascades. The final outputs are directed out of the chip, for example through waveguide-to-free space edge emission, or through grating couplers. The electro-optical modulators are controlled by an external electrical control circuit, such as a field-programmable-gate-array (FPGA) module 404.

In the system of FIG. 4, light is split into many channels, with electrical control on each channel, programmed by an FPGA (field-programmable gate array) 404. Accordingly, the system comprises a plurality of tunable beam splitters (BS) 405. The output port of the device is a phased array with specific arrangement of outputs 403 (e.g., couplers), in order to use the relative phase and amplitude of each channel to generate the required optical patterns. The output couplers can be, for example, vertical grating couplers or horizontal chip facet coupling.

In various embodiments, the output coupler may also be acoustic (surface acoustic waves). The output coupler can also be assisted using surface acoustic waves. For example, a surface acoustic wave along the waveguide effectively generates a grating on the material, and can be used to couple light out of the device as a grating coupler.

It will be appreciated that the network size in FIG. 4 is merely exemplary. In various embodiments, micro-Mach-Zehnder interferometers are used as a fundamental element to control the paths of propagating beams. In various embodiments, this is achieved on a χ(2) material platform that requires no holding current and allows for fast switching speed. The electrical switches are programmed and controlled by either an integrated electrical circuit or an external FPGA board (e.g., 404).

In various embodiments, the photonic switch element includes microring resonators.

Various systems described herein are based on a lithium niobate nanophotonic electro-optic scheme. Using the electro-optic effect, the properties of light can be controlled by electronics at high speed. The electro-optic method is linear, low power consumption, high speed, low optical loss, and can handle high power. Power consumption is low, as there is no DC holding current. Sweeping speed is very high, in some embodiments over 50 GHz. Optical loss is low, in some embodiments about 0.1 dB/cm.

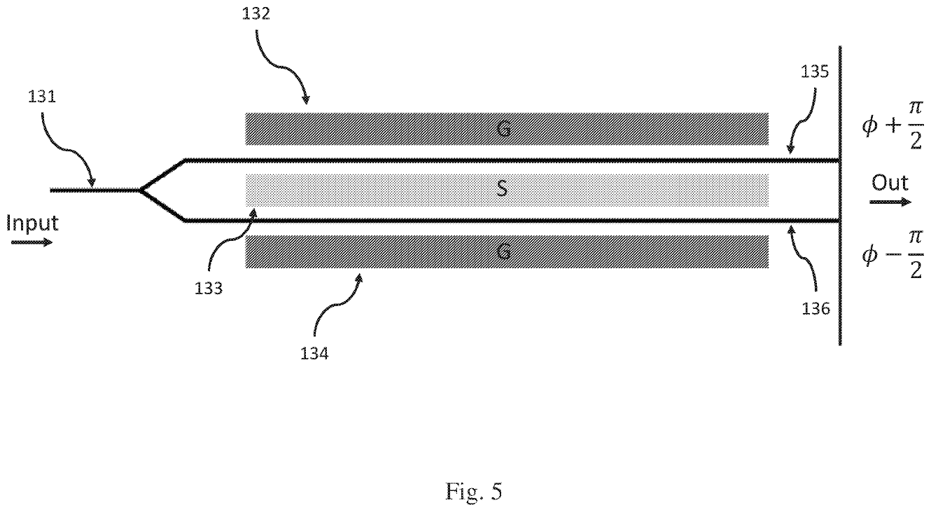

Examples of control schemes of light in each channel include:
1. Phase and amplitude control
2. Coherent control—in-phase/quadrature (I/Q)
3. Polarization control (TE/TM)
4. Push-pull type of phase output (e.g., in FIG. 5)

FIG. 5 is a schematic of a push-pull configuration of phase control. In this design, phase modulation is achieved by an applied voltage that induces opposite phase change on the two arms 132, 133 of optical waveguide 131. The controlling method of light is not limited to electro-optic for lithium niobate. The electrodes are denoted G for ground (132, 134) and S for signal (133).

The controlling method of light is not limited to electro-optic for lithium niobate.

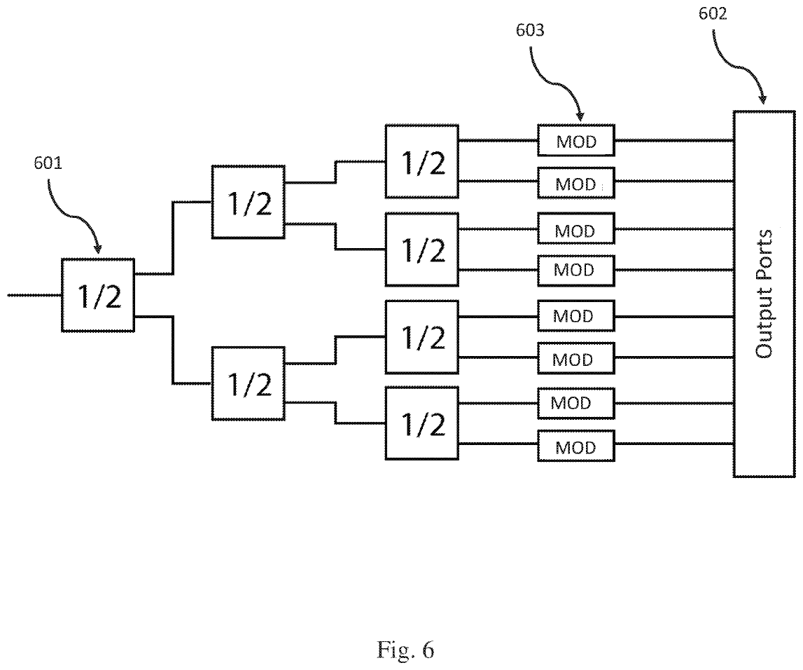

FIG. 6 is a schematic of an exemplary electro-optical switch network according to embodiments of the present disclosure. The incoming light is split 50:50 through ½ beam splitters 601. In various embodiments, beam splitter 601 is a Y-splitter or a directional coupler. This split process cascades to allow 2^{N} output ports 602, where N is the number of cascades. The final outputs are directed out of the chip, for example through waveguide-to-free space edge emission or through grating couplers. The modulators (MOD) 603 are controlled by external electrical control circuits, such as a field-programmable-gate-array (FPGA) module to control the optical intensity in each one of the output waveguides.

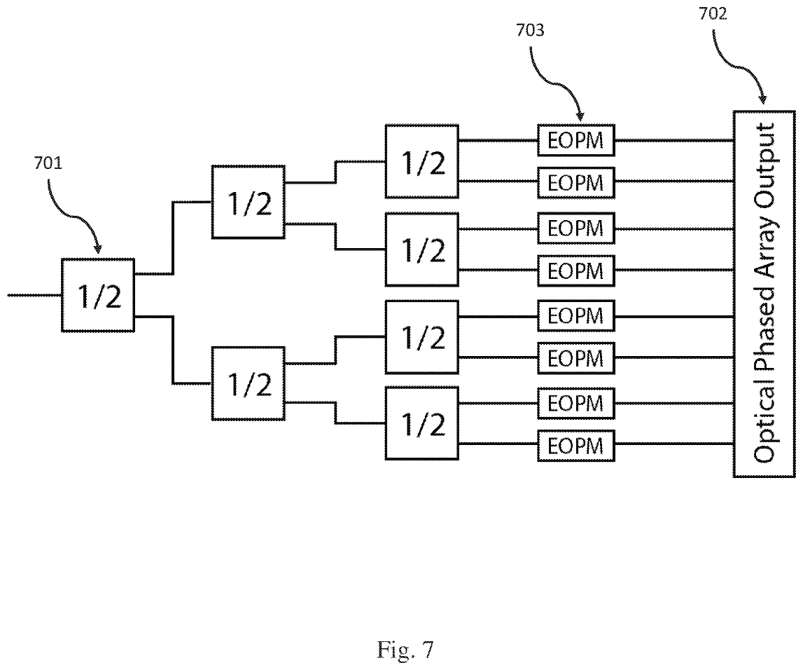

FIG. 7 is a schematic of an exemplary electro-optical switch network according to embodiments of the present disclosure. This figure shows a configuration for an electro-optical switch network that features phased-array output. The incoming light is split 50:50 through ½ beam splitters 701. In various embodiments, beam splitter 701 is a Y-splitter or a directional coupler. This split process cascades to allow 2^{N} output ports in phase array 702, where N is the number of cascades. The final outputs are directed out of the chip, for example through waveguide-to-free space edge emission or through grating couplers. The phase modulators (EOPM) 703 are controlled by an external electrical control circuits, such as a field-programmable-gate-array (FPGA) module, to control the phase of light in each one of the output waveguides. Through controlling this phase, the direction of the light from the output is reconfigured.

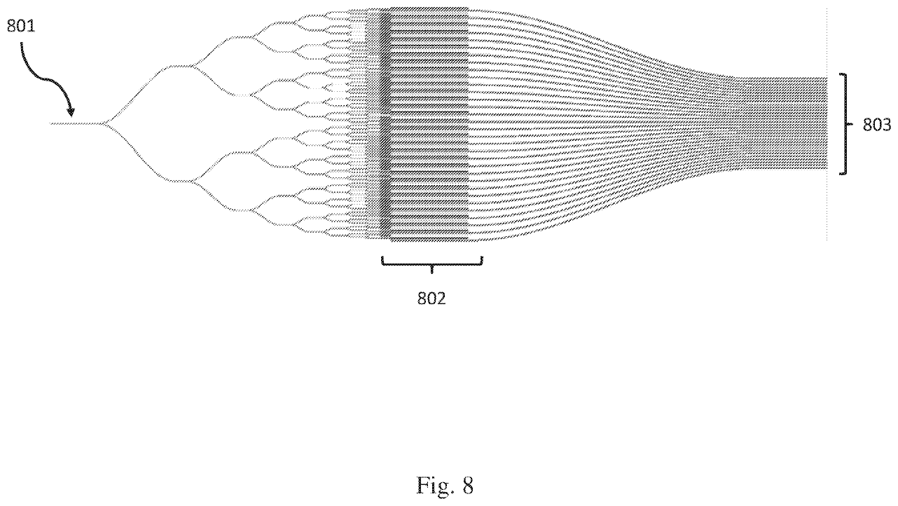

FIG. 8 is a schematic of a 1-dimensional optical-phased-array made of electro-optic phase-shifters, suitable for LiDAR systems based on a lithium niobate electro-optic platform. Here the phase control is achieved by electro-optic effect. The electro-optically controlled phase-shifter provides better performance than alternative thermo-optic methods, as discussed above.

Light Detection and Ranging (LiDAR) is used for automated cars and machine vision and sensing applications. These applications are in need of an efficient, cheap, high-speed way of steering a light beam at arbitrary angles. This can be achieved using an array of waveguides with controlled gradient on each arm. An example device with 128 channels is shown in FIG. 8. An input laser is coupled to a device input 801. Phase control is provided on each arm 802. By controlling the phase gradient on the output waveguides 803, the beam steering angle of output light can be controlled. The same system can also be used for receiving light from a particular angle.

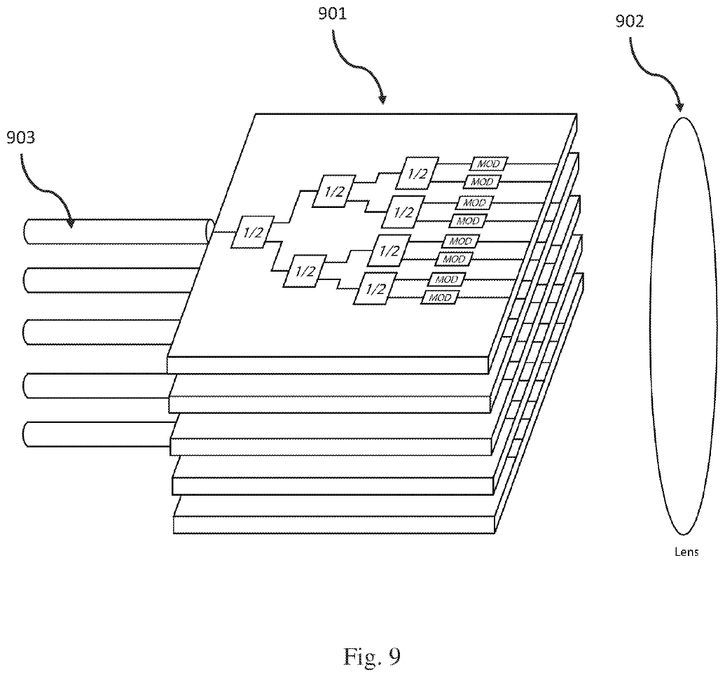

FIG. 9 is a schematics of a highly multiplexed spatial light modulator based on lithium niobate electro-optic platform. In this configuration, multiple two-dimensional chips 901 are stacked vertically to form a two-dimensional array of optical output, where each individual point can be addressed by the modulators. The optical output is mapped using a lens 902. A fiber input 903 may be provided for each chip 901.

In several quantum computing technologies, including trapped atoms and trapped ions, the system requires the capability to address hundreds or even thousands of separated spots, where atoms would be trapped, at GHz speed. This may be addressed by spatial light modulators, but such modulators are usually slow and lack the desired channel numbers.

The present disclosure provides for stacking the devices shown in FIG. 4, 6, 7, or 8 to achieve a highly multiplexed spatial light modulator (e.g., as in FIG. 9). In various embodiments, each chip has 1 input and 128 outputs. In various embodiments, each output arm is both amplitude modulated (AM) and phase modulated (PM). AM allows for output power to be controlled, and PM allows for full blown LiDAR to be implemented. The 128 outputs are mapped onto an array of atoms/ions using imaging optics.

To allow for a 2D array of atoms/ions to be addressed, multiple chips are stacked for 3D integration. Chip substrates may be thinned and precisely aligned before stacking together.

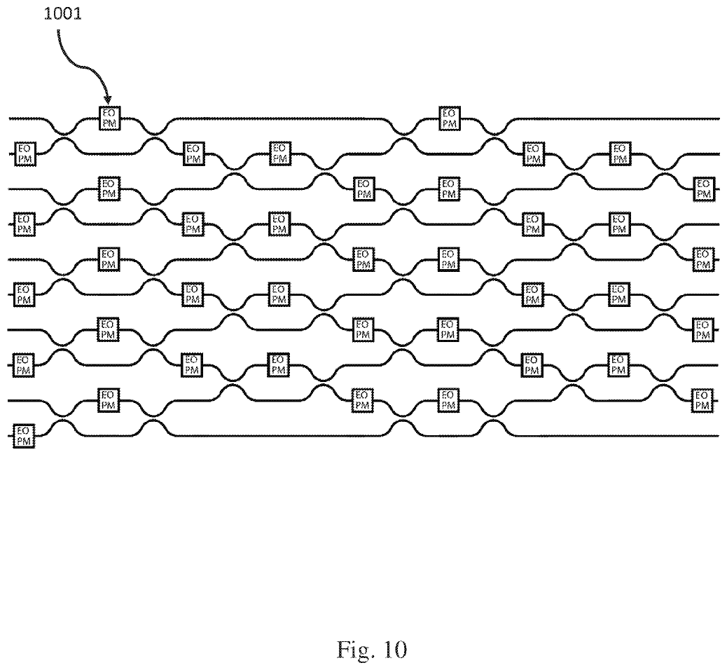

FIG. 10 is a schematic of an exemplary universal electro-optical N input N output unitary optical network. N is the number of pairs of input waveguide. In this example, N=10. For ease of illustration, this figure only shows part of the network, the full network would have three extra layers (as discussed below). The state of the light coming in on the left can be mapped arbitrary to state the goes out of the system on the right, through purely electro-optic control. As compared to alternative thermo-optical methods, the electro-optic methods described herein dramatically reduce power consumption for switching and have no steady state power consumption when held in place.

In this way, a Mach-Zehnder interferometer (MZI) switch network for optical information processing is provided. The switch network consists of a plurality of electro-optically controlled MZI interferometers 1001. The switch network is designed to be used for linear transformation, useful for optical computing, neural networks, and linear quantum optical gates.

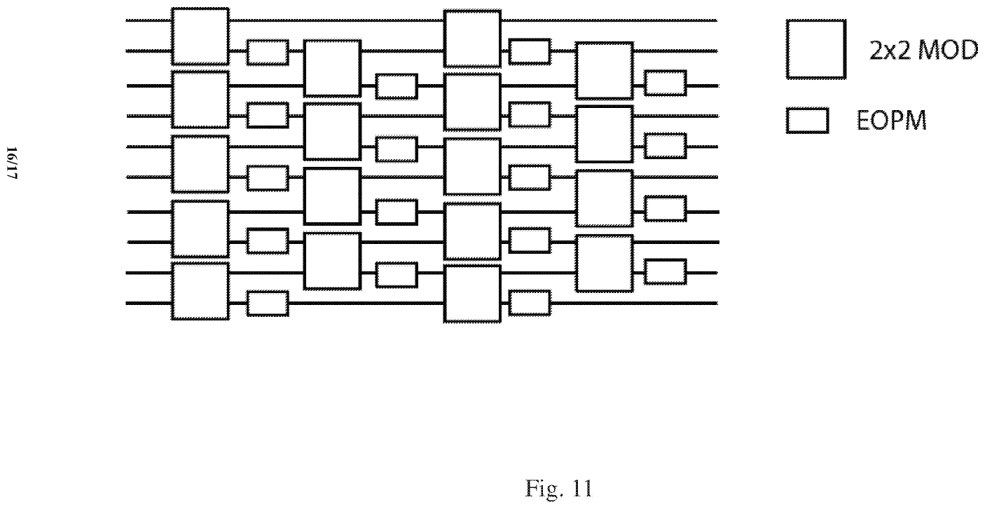

FIG. 11 is a schematic view of a universal N-to-N unitary electro-optic transformer according to embodiments of the present disclosure. This transformer is equivalent to FIG. 10. The depth of the top plot is 4, which is the depth number of the MZI modulator and phase modulator network. To complete the full function of the network, the device will have a depth of 10, equivalent to that of the number of input modes.

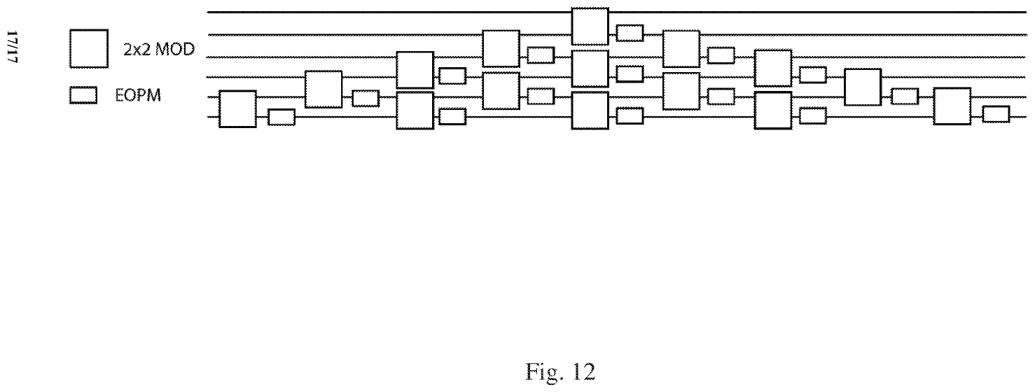

FIG. 12 is a schematic view of an additional block configuration for a universal N-to-N unitary electro-optic transformer according to embodiments of the present disclosure. In this example, the number of input modes is six. Both the configuration of FIG. 11 and that of FIG. 12 use electro-optical switches for the networks.

It will be appreciated from the above that Mach-Zehnder interferometers may be interconnected in a variety of arrangements. For example, two Mach-Zehnder interferometers are connected in series, with the outputs of a first interferometer being optically connected to the inputs of a second interferometer. In another exemplary arrangement, Mach-Zehnder interferometers are interconnected in a tree, with first and second outputs of a given interferometer being connected to the inputs of first and second interferometers, respectively. One example of a tree arrangement is shown in FIG. 4. In another exemplary arrangement, Mach-Zehnder interferometers are interconnected in an array, with first and second outputs of a given interferometer being connected to the inputs of first and second interferometers, respectively, and the first and second inputs of the given interferometer being connected to the outputs of third and fourth interferometers.

Various embodiments described herein use lithium niobate (LiNbO₃) as a waveguide material. However, the present disclosure may generally be applied to any second-order nonlinear material, that is, materials that possess second order non-linearity. In various contexts, such materials are referred to as Pockels materials. The Pockels effect is the linear electro-optic effect, where the refractive index of a medium is modified in proportion to the applied electric field strength. This effect can occur only in non-centrosymmetric materials. Exemplary second-order non-linear (χ⁽²⁾) materials include include lithium niobate (LiNbO₃), lithium tantalate (LiTaO₃), potassium niobate (KNbO₃), gallium arsenide (GaAs), potassium titanyl phosphate (KTP), lead zirconate titanate (PZT), barium titanite (BaTiO₃), LiIO₃, ammonium dihydrogen phosphate (ADP), and organic materials that possess strong Pockels effect.

With regard to lithium niobate, and other uniaxial birefringent materials, the extraordinary axis is referred to as the z-axis.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A device comprising:
a plurality of Mach-Zehnder interferometers, each Mach-Zehnder interferometer having an input and two outputs, each Mach-Zehnder interferometer comprising at least one electrode operative to control the phase or intensity of at least one of the outputs, the plurality of Mach-Zehnder interferometers being optically interconnected;
at least one controller electrically coupled to the at least one electrode of each of the plurality of Mach-Zehnder interferometers, the controller operative to individually control each electrode.

2. The device of claim 1, wherein the plurality of Mach-Zehnder interferometers are optically interconnected in series.

3. The device of claim 1, wherein the plurality of Mach-Zehnder interferometers are optically interconnected in a tree.

4. The device of claim 1, wherein the plurality of Mach-Zehnder interferometers are optically interconnected in an array.

5. The device of claim 1, wherein each Mach-Zehnder interferometer comprises a waveguide comprising a second-order nonlinear material.

6. The device of claim 1, wherein each Mach-Zehnder interferometer comprises a waveguide comprising lithium niobate or lithium tantalate.

7. The device of claim 6, wherein the waveguide is elongated in a direction perpendicular to a z-axis of the lithium niobate or lithium tantalate.

8. The device of claim 6, wherein the waveguide is elongated in a direction perpendicular to an x-axis of the lithium niobate or lithium tantalate.

9. (canceled)

10. (canceled)

11. (canceled)

12. The device of claim 1, wherein each Mach-Zehnder interferometer comprises a first and second arm, and wherein a first electrode of the at least one electrode of each Mach-Zehnder interferometer is disposed parallel to the first and second arm of the corresponding Mach-Zehnder interferometer.

13. The device of claim 12, wherein the first electrode is disposed between and coplanar to the first and second arm of the corresponding Mach-Zehnder interferometer.

14. The device of claim 12, wherein a second electrode of the at least one electrode of each Mach-Zehnder interferometer is disposed parallel to the first and second arm of the corresponding Mach-Zehnder interferometer.

15. The device of claim 14, wherein the second electrode is disposed coplanar to the first and second arm of the corresponding Mach-Zehnder interferometer, the first arm being disposed between the first electrode and the second electrode.

16. The device of claim 12, wherein a third electrode of the at least one electrode of each Mach-Zehnder interferometer is disposed parallel to the first and second arm of the corresponding Mach-Zehnder interferometer.

17. The device of claim 10, wherein the third electrode is disposed coplanar to the first and second arm of the corresponding Mach-Zehnder interferometer, the second arm being disposed between the first electrode and the third electrode.

18. The device of claim 1, wherein each output of each Mach-Zehnder interferometer has an electro-optic coefficient of at least 2 pm/V.

19. The device of claim 1, wherein the at least one electrode has an efficiency of at most 10 V*cm.

20. The device of claim 1, wherein each of the plurality of Mach-Zehnder interferometers comprises a ridge portion extending from a slab portion, the ridge portion having a height perpendicular to the slab portion and a width parallel to the slab portion.

21. The device of claim 20, wherein the ridge portion has a cross sectional area of at most 5 μm².

22. (canceled)

23. The device of claim 20, wherein the slab portion has a thickness of 5 nm to 1000 nm.

24. The device of claim 20, wherein the height of the ridge portion is from 50 nm to 1000 nm.

25. The device of claim 20, wherein the width of the ridge portion is from 100 nm to 5000 nm.

26. (canceled)

27. The device of claim 20, wherein the plurality of Mach-Zehnder interferometers comprise a SiO₂ cladding.

28. A device comprising:
a plurality of beam splitters, each beam splitter having an input and two outputs, the plurality of beam splitters being optically interconnected in a tree having an optical input and a plurality of optical outputs;
a plurality of electrodes, each operative to control the phase of one of the optical outputs;
at least one controller electrically coupled to the plurality of electrodes, the controller operative to individually control each electrode.

29. The device of claim 28, wherein each of the plurality of optical outputs comprises a waveguide comprising a second-order nonlinear material.

30. The device of claim 28, wherein each of the plurality of optical outputs comprises a waveguide comprising lithium niobate or lithium tantalate.

31. The device of claim 30, wherein the waveguide is elongated in a direction perpendicular to a z-axis of the lithium niobate or lithium tantalate.

32. The device of claim 30, wherein the waveguide is elongated in a direction perpendicular to an x-axis of the lithium niobate or lithium tantalate.

33. (canceled)

34. (canceled)

35. (canceled)

36. The device of claim 28, wherein each output of each beam splitter has an electro-optic coefficient of at least 2 pm/V.

37. The device of claim 28, wherein the at least one electrode has an efficiency of at most 10 V*cm.

38. The device of claim 28, wherein each of the plurality of beam splitters comprises a ridge portion extending from a slab portion, the ridge portion having a height perpendicular to the slab portion and a width parallel to the slab portion.

39. The device of claim 38, wherein the ridge portion has a cross sectional area of at most 5 μm².

40. (canceled)

41. The device of claim 38, wherein the slab portion has a thickness of 5 nm to 1000 nm.

42. The device of claim 38, wherein the height of the ridge portion is from 50 nm to 1000 nm.

43. The device of claim 38, wherein the width of the ridge portion is from 100 nm to 5000 nm.

44. (canceled)

45. The device of claim 38, wherein the plurality of beam splitters comprise a SiO₂ cladding.

46. A device comprising:
a plurality of layers, each layer comprising:
a plurality of beam splitters, each beam splitter having an input and two outputs, the plurality of beam splitters being optically interconnected in a tree having an optical input and a plurality of optical outputs;
a plurality of electrodes, each operative to control the phase of one of the optical outputs;
at least one controller electrically coupled to the plurality of electrodes of each layer, the controller operative to individually control each electrode;
a planar array of optical outputs, optically coupled to the optical outputs of each layer.

47. The device of claim 46, wherein each of the plurality of optical outputs of each layer comprises a waveguide comprising a second-order nonlinear material.

48. The device of claim 46, wherein each of the plurality of optical outputs of each layer comprises a waveguide comprising lithium niobate or lithium tantalate.

49. The device of claim 48, wherein the waveguide is elongated in a direction perpendicular to a z-axis of the lithium niobate or lithium tantalate.

50. The device of claim 48, wherein the waveguide is elongated in a direction perpendicular to an x-axis of the lithium niobate or lithium tantalate.

51. A method of beam-steering, comprising:
providing an optical input to a plurality of beam splitters, each beam splitter having an input and two outputs, the plurality of beam splitters being optically interconnected in a tree having an optical input and a plurality of optical outputs;
individually controlling each of a plurality of electrodes by a controller, the controller electrically coupled to the plurality of electrodes, each of the plurality of electrodes operative to control the phase of one of the optical outputs.

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)
